(19) United States
(12) Patent Application Publication
(10) Pub. No.: US 2017/0169474 A1
(43) Pub. Date: Jun. 15, 2017

(54) INTERNET-BASED DISPLAY MATERIAL SYSTEM AND INTERNET-BASED DISPLAY MATERIAL PRODUCING METHOD

(71) Applicant: BEIJING KNET EQXIU TECHNOLOGY CO., LTD., BEIJING (CN)

(72) Inventors: DIANSHENG LU, BEIJING (CN); JIN HUANG, BEIJING (CN); WEI MAO, BEIJING (CN); WEIMING ZHU, BEIJING (CN); XIAOYAN LI, BEIJING (CN); QIFU GENG, BEIJING (CN); YI TANG, BEIJING (CN); FUCAI LIU, BEIJING (CN)

(21) Appl. No.: 15/151,349

(22) Filed: May 10, 2016

(30) Foreign Application Priority Data
Dec. 15, 2015 (CN) 201510930091.3

(51) Int. Cl. G06Q 30/02; G06Q 50/00; G06Q 30/00; H04L 29/08

(52) U.S. Cl. CPC G06Q 30/0267; H04L 67/22; H04L 67/306; G06Q 50/01; G06Q 30/01

(57) ABSTRACT

The present invention provides an Internet-based display material system and a producing method thereof, the system is applied at mobile terminal, comprising: a display material managing module, configured to produce display material, or edit and manage the produced display material; a publishing module, configured to publish the display material produced or edited by the display material managing module to Internet social networking platform; and a customer information managing module, configured to manage customer information of customer browsing the display material published by the publishing module. Through the system provided by the present invention, the user can conveniently edit, manage and publish the display material, therefore, the system is time efficient and is suitable for rapid development of the enterprise. Meanwhile, customer information is managed over the Internet, so that communication and interaction with the customer is conducted in real time, and effect of popularizing the display material is improved.

### CROSS-REFERENCE TO RELATED APPLICATIONS

This application claims priority to Chinese Patent Application No. 201510930091.3, filed on Dec. 15, 2015, the content of which is incorporated herein by reference in its entirety.

### TECHNICAL FIELD

The present invention relates to the field of Internet technology and, in particular, to an Internet-based display material system and an Internet-based display material producing method.

### BACKGROUND

With the rapid development and popularization of the mobile network, Internet marketing has become an important means for an enterprise to display and promote its own products or services. An enterprise user usually introduces products or services of the enterprise via a display material and promotes the display material over the Internet. The display material particularly can include contents, such as text, picture, animation and video.

In the prior art, if the enterprise user intends to design and promote a display material over the Internet, multiple links, such as static page design, page code development, third-party testing, third-party deployment are needed.

However, various problems, for example, substantial enterprise resources are consumed, procedures are lengthy, adjustments are complicated, occurred in the prior art.

### SUMMARY

Embodiments of the present invention provide an Internet-based display material system and an Internet-based display material producing method, so as to solve the problem in the prior art that the manner for designing a display material of the enterprise consumes substantial enterprise resources.

Embodiments of the present invention provide an Internet-based display material system applied at a mobile terminal, including: a display material managing module, configured to produce the display material, or edit and manage the produced display material; a publishing module, configured to publish the display material produced or edited by the display material managing module to an Internet social networking platform; and a customer information managing module, configured to manage customer information of a customer browsing the display material published by the publishing module.

In another embodiment, the display material managing module includes:

a display material list sub-module, configured to save and display the produced display material;

a creating sub-module, configured to create a new display material design page;

an editing sub-module, configured to edit the produced display material in the display material list sub-module, or edit contents of the new display material design page created by the creating sub-module.

In another embodiment, the system further includes:

a data statistics module, configured to collect display data of the display material and information of a browsing customer through the Internet social networking platform.

In another embodiment, the customer information managing module includes:

a customer information list sub-module, configured to save customer information of the display material and display a customer information list of the display material.

In another embodiment, the customer information managing module further includes:

a customer information creating sub-module, configured to add customer information in the customer information list according to the customer information collected by the data statistics module.

In another embodiment, the customer information managing module further includes: a customer information importing sub-module, configured to import the customer information collected by the data statistics module into the customer information list.

In another embodiment, the customer information managing module further includes: a customer module interacting module, configured to interact with a customer according to the customer information in the customer information list saved by the customer list sub-module.

In another embodiment, the system further includes a user account managing module, configured to manage rights of using the display material managing module, the publishing module and the customer information managing module.

In another embodiment, the user account managing module is further configured to authorize a user to use the display material managing module, the publishing module and the customer information managing module with a third party account.

Embodiments of the present invention also provide an Internet-based display material producing method, including:

producing the display material, or editing and managing the produced display material;

publishing the produced or edited display material to an Internet social networking platform;

managing customer information of a customer browsing the display material.

In another embodiment, the producing the display material, or editing and managing the produced display material, includes:

creating the display material design page, or editing contents of the produced display material design page;

saving and displaying the produced display material.

In another embodiment, after publishing the produced or edited display material to an Internet social networking platform, the method further includes:

collecting display data of the display material and information of a browsing customer through the Internet social networking platform.

In another embodiment, the managing customer information of the customer browsing the display material, includes:

saving customer information of the display material and displaying a customer information list of the display material.

In another embodiment, the managing customer information of the customer browsing the display material, further includes:

adding customer information in the customer information list according to the collected customer information.

In another embodiment, the managing customer information of the customer browsing the display material, further includes: importing the collected customer information into the customer information list.

In another embodiment, the managing customer information of the customer browsing the display material, further includes: interacting with a customer according to the customer information in the customer information list saved by the customer list sub-module.

In another embodiment, the method further includes: managing the display material produced by a user, or editing and managing the produced display material; publishing the produced or edited display material to an Internet social networking platform; and managing rights of customer information of the customer browsing the display material.

In another embodiment, the method further includes: authorizing a user to use a third party account to produce the display material, or edit and manage the produced display material; publish the produced or edited display material to an Internet social networking platform; and manage rights of customer information of the customer browsing the display material.

Embodiments of the present invention also provide an Internet-based display material system, including: a processor and a memory for storing instructions to be executed, when the system is in operation, the processor communicates with the memory, and the processor executes the instructions, so that the system executes any of the methods described above.

In the Internet-based display material system and the Internet-based display material producing method, as well as the Internet-based display material system applied at a mobile terminal provided in the embodiments of the present invention, the display material managing module designs or manages the display material, the publishing module publishes the display material produced or edited by the display material managing module to an Internet social networking platform, and the customer information managing module manages customer information of the customer browsing the display material. By adopting the Internet-based display material system provided in the embodiments of the present invention, the user can conveniently edit, manage and publish the display material, therefore, the system is so time efficient that it is suitable for rapid development of the enterprise. Meanwhile, the customer information is managed over the Internet, so that communication and interaction with the customer can be conducted in real time, and the effect of popularizing the display material can be improved.

### BRIEF DESCRIPTION OF DRAWINGS

In order to illustrate embodiments of the present invention or the technical solution in the prior art more clearly, accompanying drawings needed for describing the embodiments or the prior art will be introduced in brief hereinafter. Apparently, the accompanying drawings show certain embodiments of the invention, and persons skilled in the art can derive other drawings from them without creative efforts.

FIG. 1 is a schematic structural diagram of an Internet-based display material system according to an embodiment of the present invention;

FIG. 2 is a schematic structural diagram of an Internet-based display material system according to another embodiment of the present invention;

FIG. 3 is a flowchart of an Internet-based display material producing method according to an embodiment of the present invention;

FIG. 4 is a schematic structural diagram of an Internet-based display material system according to another embodiment of the present invention;

FIG. 5 is a schematic diagram of a first layer interface in a graphic user interface GUI of an Internet-based display material system according to an embodiment of the present invention;

FIG. 6 is a schematic diagram of a scenario creating mode selection interface in a GUI according to an embodiment of the present invention; and

FIG. 7 is a schematic diagram of a display material creating interface in a GUI according to an embodiment of the present invention.

### DESCRIPTION OF EMBODIMENTS

In order to make the objects, technical solutions, and advantages of the embodiments of the present invention clearer, the technical solutions in the embodiments of the present invention are hereinafter described clearly and completely with reference to the accompanying drawings in the embodiments of the present invention. Obviously, the embodiments described here are part of the embodiments of the present invention and not all of the embodiments. All other embodiments, which can be derived by persons skilled in the art from the embodiments given herein without creative efforts, shall fall within the protection scope of the present invention.

The Internet-based display material system provided in the embodiments of the present invention is used for assisting a user to design a desired display material via a mobile terminal, publish the display material over the Internet so as to promote and popularize products or services of the user, collect information of a customer browsing the display material over the Internet, interact with the customer in real time, and collect opinions and advices of the customer on products or services promoted by the display material.

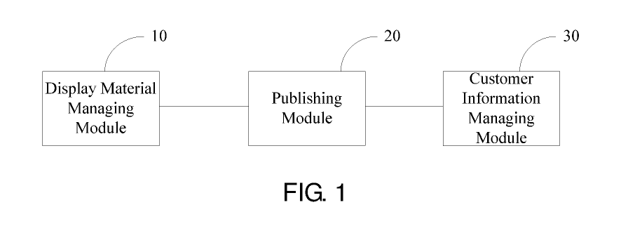

FIG. 1 is a schematic structural diagram of an Internet-based display material system according to an embodiment of the present invention. Please refer to FIG. 1, the Internet-based display material system applied at a mobile terminal, including:

a display material managing module 10, configured to produce the display material, or edit and manage the produced display material;

a publishing module 20, configured to publish the display material produced or edited by the display material managing module to an Internet social networking platform;

a customer information managing module 30, configured to manage customer information of a customer browsing the display material published by the publishing module.

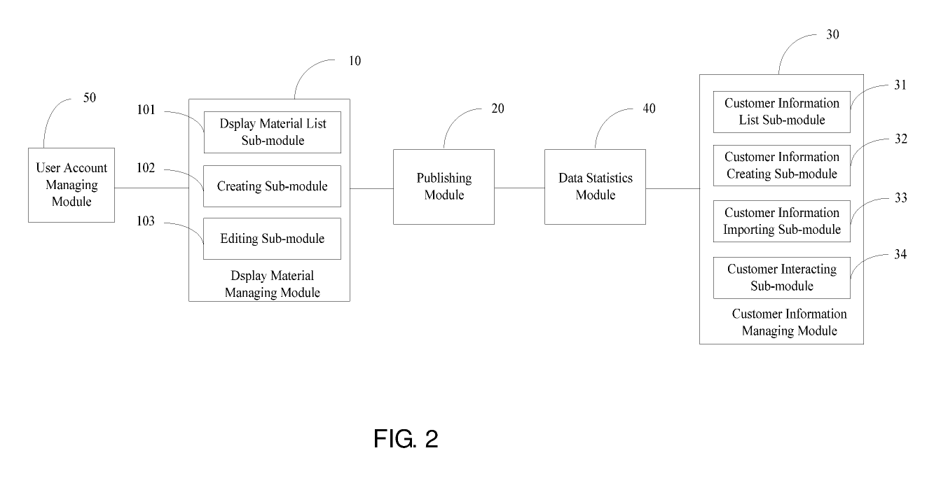

FIG. 2 is a schematic structural diagram of an Internet-based display material system according to another embodiment of the present invention. Please refer to FIG. 2, in particular, the display material managing module 10 includes:

a display material list sub-module 101, configured to display the completed display material;

a creating sub-module 102, configured to create a new display material design page;

an editing sub-module 103, configured to edit the produced display material in the display material list sub-module, or edit contents of the new display material design page created by the creating sub-module.

In particular, the display material managing module 10 can be configured as a function button on top of the display page of the mobile terminal, the user can enter the display material list sub-module 101 by clicking this button, and then can create a new display material with the creating sub-module 102, or edit and manage the completed display material in the display material list with the editing sub-module 103. Meanwhile, the editing sub-module 103 also can edit the newly created display material. The produced display material can be published to an Internet social networking platform, such as other social network applications on the mobile terminal, with the publishing module 20, so as to achieve rapid social self-marketing. After the publishing module 20 publishes the display material, the customer information managing module 30 manages customer information fed back by the customer browsing the display material over the Internet.

In the Internet-based display material system applied at a mobile terminal provided in the embodiments of the present invention, the display material managing module designs or manages the display material, the publishing module publishes the display material produced or edited by the display material managing module to an Internet social networking platform, and the customer information managing module manages customer information of the customer browsing the display material. By adopting the Internet-based display material system provided in the embodiments of the present invention, the user can conveniently edit, manage and publish the display material, therefore, the system is so time efficient that it is suitable for rapid development of the enterprise. Meanwhile, the customer information is managed over the Internet, so that communication and interaction with the customer can be conducted in real time, and the effect of popularizing the display material can be improved.

Please refer to FIG. 2, furthermore, to facilitate analyzing the condition of the display material and improve the popularizing and advertising effect of the display material, the system further includes a data statistics module 40, configured to collect display data of the display material and information of a browsing customer through the Internet social networking platform. In particular, the display material is designed with a survey form, after publishing over the Internet, the browsing customer can fill in feedback information on the survey form. Through the data statistics module 40 counting data collected by the survey form, the user can view the popularizing data of the display material in real time.

In particular, the function button corresponding to the customer information managing module 30 can be provided below the function button corresponding to the display material managing module 10. The customer information managing module 30 includes a customer information list sub-module 31, a customer information creating sub-module 32, a customer information importing sub-module 33 and a customer interacting sub-module 34. Click the function button corresponding to the customer information managing module 30 to enter display interfaces of the customer information list sub-module 31, the customer information creating sub-module 32, the customer information importing sub-module 33 and the customer interacting sub-module 34. Each of the sub-modules is to perform the following functions, respectively:

The customer information list sub-module 31 is configured to save customer information of the display material and display a customer information list of the display material. After the display material is published by the publishing module 20, customer information is fed back by the customer browsing the display material over the Internet, then is saved in a manner of a customer information list by the customer information list sub-module 31, and is displayed on a page in the display material system of the mobile terminal.

The customer information creating sub-module 32 is configured to add customer information in the customer information list according to the customer information collected by the data statistics module 40.

The customer information importing sub-module 33 is configured to import the customer information collected by the data statistics module 40 into the customer information list.

In particular, the user can add customer information with the customer information creating sub-module 32, or automatically import the customer information in batches into the customer information list with the customer information importing sub-module 33.

The customer module interacting module 34 is configured to interact with a customer according to the customer information in the customer information list saved by the customer list sub-module, for example, by making a phone call, sending a message, or the like. Therefore, the user can get feedback opinions on the display material in time, know the effect of popularizing of the display material, and maintain and manage the display material based on customer feedback.

Furthermore, the system further includes a user account managing module 50, configured to manage rights of using the display material managing module 10, the publishing module 20 and the customer information managing module 30. The user can register a login account of the Internet-based display material system with the user account managing module 50, and edit and set the login account. The user can log in the Internet-based display material system with the login account on any mobile terminal, and edit, manage and publish the display material created by the same account, so as to improve maintenance timeliness of the display material and adapt rapid development of the enterprise.

In particular, the user account managing module 50 is further configured to authorize a user to use the display material managing module 10, the publishing module 20 and the customer information managing module 30 with a third party account. For example, the user is allowed to log in the Internet-based display material system with a WeChat, QQ or MicroBlog account to create the display material, or edit, manage and publish the display material created by the same account, and manage the customer information.

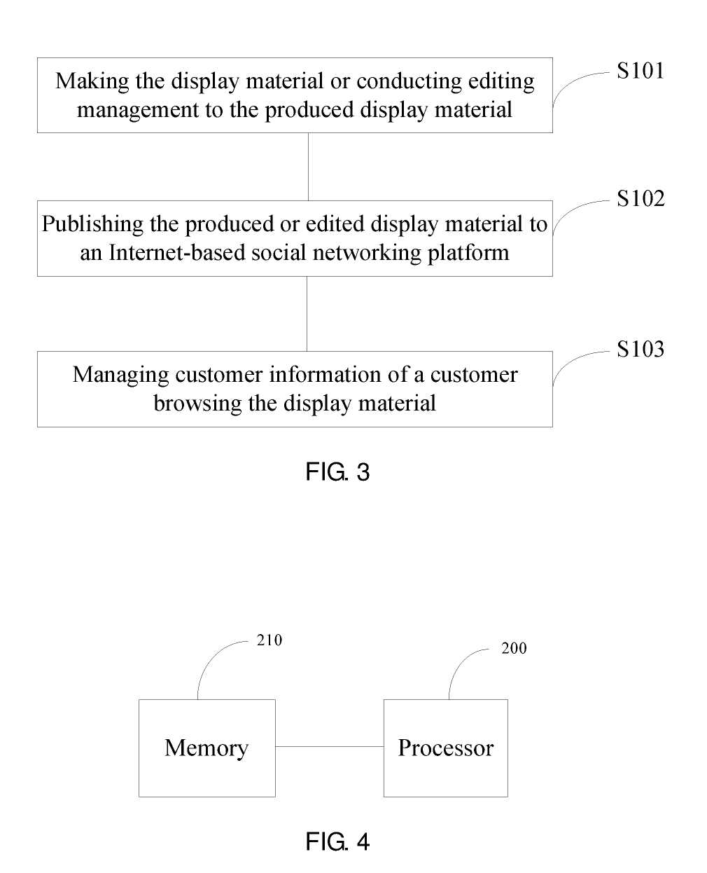

Embodiments of the present invention also provide an Internet-based display material producing method. FIG. 3 is a flowchart of an Internet-based display material producing method according to an embodiment of the present invention. Please refer to FIG. 3, the method includes:

S101, Producing the display material, or editing and managing the produced display material;

S102, Publishing the produced or edited display material to an Internet social networking platform;

S103, Managing customer information of a customer browsing the display material.

In the Internet-based display material producing method applied at a mobile terminal provided in the embodiments of the present invention, the display material is published to an Internet social networking platform after being produced or edited, and customer information of the customer browsing the display material is managed over the Internet. By adopting the Internet-based display material system provided in the embodiments of the present invention, the user can conveniently edit, manage and publish the display material, therefore, the system is so time efficient that it is suitable for rapid development of the enterprise. Meanwhile, the customer information is managed over the Internet, so that communication and interaction with the customer can be conducted in real time, and the effect of popularizing the display material can be improved.

Furthermore, the producing the display material, or editing and managing the produced display material, includes:

creating a display material design page, or editing contents of the produced display material design page;

saving and displaying the produced display material;

Furthermore, after publishing the produced or edited display material to an Internet social networking platform, the method further includes:

collecting display data of the display material and information of a browsing customer through the Internet social networking platform.

Furthermore, the managing customer information of the customer browsing the display material, includes:

saving customer information of the display material and displaying a customer information list of the display material.

Furthermore, the managing customer information of the customer browsing the display material, further includes:

adding customer information in the customer information list according to the collected customer information.

Furthermore, the managing customer information of the customer browsing the display material, further includes: importing the collected customer information into the customer information list.

Furthermore, the managing customer information of the customer browsing the display material, further includes: interacting with a customer according to the customer information in the customer information list saved by the customer list sub-module.

Furthermore, the method further includes: managing the display material produced by a user, or editing and managing the produced display material; publishing the produced or edited display material to an Internet social networking platform; and managing rights of customer information of the customer browsing the display material.

Furthermore, the method further includes: authorizing a user to use a third party account to produce the display material, or edit and manage the produced display material; publish the produced or edited display material to an Internet social networking platform; and manage rights of customer information of the customer browsing the display material.

Embodiments of the present invention also provide an Internet-based display material system. FIG. 4 is a schematic structural diagram of an Internet-based display material system according to another embodiment of the present invention. Please refer to FIG. 4, the system includes: a processor 200 and a memory 210 for storing instructions to be executed, when the system is in operation, the processor 200 communicates with the memory 210, and the processor 200 executes the instructions, so that the system executes any of the methods in the above method embodiments. The technical effect and the implementation principle thereof are similar to those of the method embodiments, and no further details will be given here.

The present invention also provides a graphic user interface (Graphic User Interface, GUI) of an Internet-based display material system, for assisting a user to design products or display materials for service, and achieving propaganda and popularization of the products or services of the user by publishing the display material to an Internet social networking platform. The GUI is applied at the mobile terminal.

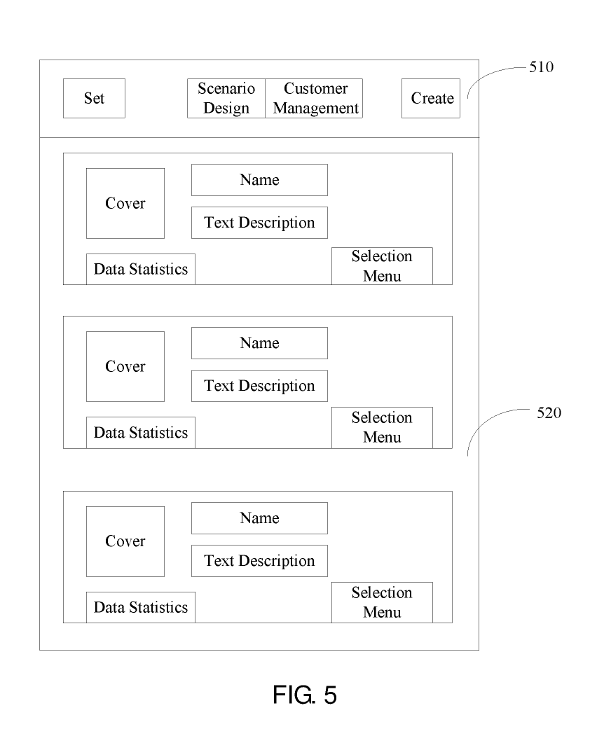

FIG. 5 is a schematic diagram of a first layer interface in a graphic user interface GUI of an Internet-based display material system according to an embodiment of the present invention. Please refer to FIG. 5, the GUI provided in the embodiments of the present invention includes a multilayer interface, and the first layer interface of the GUI includes a function selecting area 510 and a list displaying area 520. Optionally, the function selecting area 510 is located above the list displaying area 520.

A scenario design button and a customer management button for the display material are provided in the middle of the function selecting area 510, and located on top of the first layer interface of the GUI. When the scenario design button is selected, the list displaying area 520 displays the saved and published display material list. When the customer management button is selected, the list displaying area 520 displays the saved customer information list. A set button is provided on one side of the function selecting area 510. Click the set button to enter the setting interface and set the user account and attributes of the display material. A create button is provided on another side of the function selecting area 510. When the scenario design button is selected, click the create button to enter the scenario design interface; when the customer management button is selected, click the create button to enter the customer information importing interface.

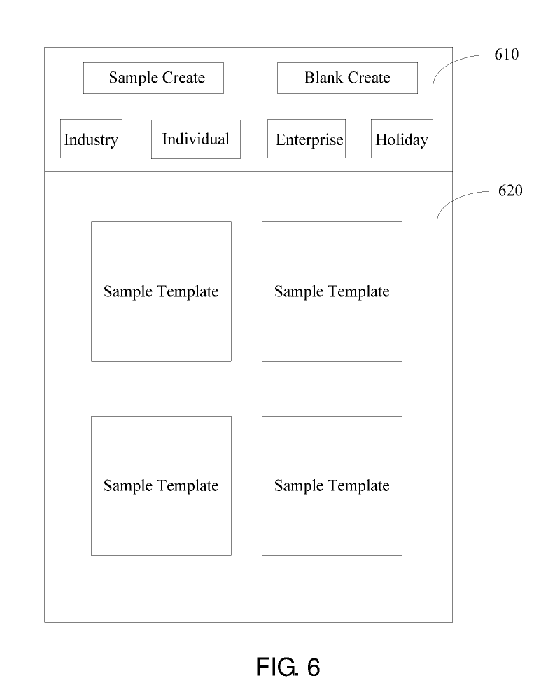

FIG. 6 is a schematic diagram of a scenario creating mode selection interface in a GUI according to an embodiment of the present invention. Please refer to FIG. 6, the scenario creating mode selection interface includes a scenario creating mode selecting area 610 and a template displaying area 620. The scenario creating mode selecting area 610 includes a sample create button and a blank create button. When the sample create button is selected, the template displaying area 620 displays a sample template of the display material. The sample template can be classified into various types, such as industry, individual, enterprise and holiday. Select a sample template, then enter the display material creating interface, edit to produce the desired display material on the basis of the sample template. When the blank create button is selected, then directly enters the display material creating interface, edit on a blank page to produce the desired display material.

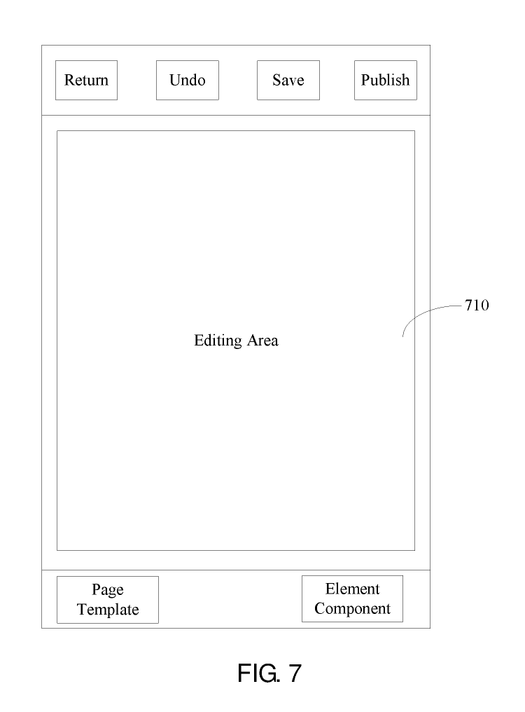

FIG. 7 is a schematic diagram of a display material creating interface in a GUI according to an embodiment of the present invention. Please refer to FIG. 7, particularly, the display material creating interface includes an editing area 710. The editing area 710 is located in the middle of the display material creating interface, and a page template button and an element component button are provided below the editing area 710. Click the page template button to display page templates of different types, such as, format template, style template, interactive template and self-defined template, so as to create the display material page according to the selected template. Click the element component button to display multiple element components for producing the display material, such as text, picture, background, special-effect, music or page-turning mode. An undo button, a save button and a publish button are provided above the editing area 710. Click the undo button, then undo the previous edit actions; click the save button, then save the currently-edited page content; click the publish button, then save the currently-edited display material in the Internet-based display material system and enter a publishing setting interface. The publishing setting interface includes a basic information setting area and a publishing platform selecting area. The basic information setting area can set contents, such as name, cover and description of the display material. The publishing platform selecting area can display multiple social networking platforms, such as WeChat, Twitter, QQ, Qzone, MicroBlog and Facebook. Select one social networking platform, then publish the produced display material to the social networking platform over the Internet.

After the display material is published, the customer browsing the display material can feed back information by filling in the self-contained form of the display material. After the user selects the customer management button in the GUI, click the create button, then enter the customer information importing interface to import the customer information collected by the display material into the customer information list.

The GUI of the Internet-based display material system applied at a mobile terminal provided in the embodiments of the present invention can make the user conveniently design the desired display material on the mobile terminal, and can modify, update and publish the display material at any time, therefore, the GUI is so time efficient that it is suitable for rapid development of the enterprise.

Furthermore, each display material display interface in the display material list includes a cover of the display material, name and text description of the display material are displayed at one side of the cover. A data statistics button and a menu selection button are provided below the cover, name and text description. Click the data statistics button to display a web browsing data of the display material. Click the menu selection button to display multiple menu options, such as open/close, edit, share, copy and delete. Particularly, the open/close option is used to open or close a publishing state of the display material.

When the display material is designed and published with the GUI of the Internet-based display material system, the user can select the page design template in the page template area, select the desired element component in the element component toolbar, edit the page template and the element component in the editing area, process pages of the display material in the page process area, set attributes of the display material in the second layer interface of the set button, and publish the produced display material to an Internet social networking platform with the publishing button.

The present invention also provides a computer readable storage medium comprising program instructions for enabling the computer to implement the Internet-based display material producing method provided in the method embodiments, or enabling the computer to display the GUI of the Internet-based display material system provided in the above embodiments. The technical effects brought by the computer readable storage medium are similar to those of the GUI, and no further details will be given here. Finally, it should be noted that the above embodiments are merely provided for describing the technical solutions of the present invention, but not intended to limit the present invention.

It should be understood by persons skilled in the art that although the present invention has been described in detail with reference to the foregoing embodiments, modifications can be made to the technical solutions described in the foregoing embodiments, or equivalent replacements can be made to partial or all technical features in the technical solutions; however, such modifications or replacements do not cause the essence of corresponding technical solutions to depart from the scope of the embodiments of the present invention.

What is claimed is:

1. An Internet-based display material system applied at a mobile terminal, comprising:
a display material managing module, configured to produce the display material, or edit and manage the produced display material;
a publishing module, configured to publish the display material produced or edited by the display material managing module to an Internet social networking platform; and
a customer information managing module, configured to manage customer information of a customer browsing the display material published by the publishing module.

2. The system according to claim 1, wherein the display material managing module comprises:
a display material list sub-module, configured to save and display the produced display material;
a creating sub-module, configured to create a new display material design page; and
an editing sub-module, configured to edit the produced display material in the display material list sub-module, or edit contents of the new display material design page created by the creating sub-module.

3. The system according to claim 1, further comprising:
a data statistics module, configured to collect display data of the display material and information of a browsing customer through the Internet social networking platform.

4. The system according to claim 3, wherein the customer information managing module comprises:
a customer information list sub-module, configured to save customer information of the display material and display a customer information list of the display material.

5. The system according to claim 4, wherein the customer information managing module further comprises:
a customer information creating sub-module, configured to add customer information in the customer information list according to the customer information collected by the data statistics module.

6. The system according to claim 4, wherein the customer information managing module further comprises: a customer information importing sub-module, configured to import the customer information collected by the data statistics module into the customer information list.

7. The system according to claim 4, wherein the customer information managing module further comprises: a customer module interacting module, configured to interact with a customer according to the customer information in the customer information list saved by the customer list sub-module.

8. The system according to claim 1, further comprising a user account managing module, configured to manage rights of using the display material managing module, the publishing module and the customer information managing module.

9. The system according to claim 8, wherein, the user account managing module is further configured to authorize a user to use the display material managing module, the publishing module and the customer information managing module with a third party account.

10. An Internet-based display material producing method, comprising:
producing the display material, or editing and managing the produced display material;
publishing the produced or edited display material to an Internet social networking platform; and
managing customer information of a customer browsing the display material.

11. The method according to claim 10, wherein, the producing the display material, or editing and managing the produced display material, comprises:
creating a display material design page, or editing contents of the produced display material design page;
saving and displaying the produced display material.

12. The method according to claim 10, wherein, after publishing the produced or edited display material to the Internet social networking platform, the method further comprises:
collecting display data of the display material and information of a browsing customer through the Internet social networking platform.

13. The method according to the claim 12, wherein, the managing customer information of the customer browsing the display material, comprises:
saving customer information of the display material and displaying a customer information list of the display material.

14. The method according to the claim 13, wherein, the managing customer information of the customer browsing the display material, further comprises:
adding customer information in the customer information list according to the collected customer information.

15. The method according to the claim 13, wherein, the managing customer information of the customer browsing the display material, further comprises: importing the collected customer information into the customer information list.

16. The method according to the claim 13, wherein, the managing customer information of the customer browsing the display material, further comprises: interacting with a customer according to the customer information in the customer information list saved by the customer list sub-module.

17. The method according to claim 10, further comprising: managing the display material produced by a user, or editing and managing the produced display material; publishing the produced or edited display material to an Internet social networking platform; and managing rights of customer information of the customer browsing the display material.

18. The method according to claim 10, further comprising: authorizing a user to use a third party account to produce the display material, or edit and manage the produced display material; publish the produced or edited display material to an Internet social networking platform; and manage rights of customer information of the customer browsing the display material.

19. An Internet-based display material system, comprising: a processor and a memory for storing instructions to be executed, when the system is in operation, the processor communicates with the memory, and the processor executes the instructions, so that the system executes the method according to claim 10.
